(19) United States
(12) Patent Application Publication
(10) Pub. No.: US 2025/0276409 A1
(43) Pub. Date: Sep. 4, 2025

(54) SMART LASER WELDING

(71) Applicant: Rivian IP Holdings, LLC, Irvine, CA (US)

(72) Inventors: Yingtao TIAN, Pflugerville, TX (US); Umair SHAH, Normal, IL (US); John Joseph HASIER, Anaheim, CA (US); Meiyu ZHAI, Irvine, CA (US); Zhangli HU, Sunnyvale, CA (US); Venu Gopal Krishnardula, Downers Grove, IL (US); Nathan Robert PLOW, Costa Mesa, CA (US)

(21) Appl. No.: 19/053,207

(22) Filed: Feb. 13, 2025

Related U.S. Application Data
(60) Provisional application No. 63/560,599, filed on Mar. 1, 2024.

(51) Int. Cl. B23K 31/00; B23K 26/03; B23K 101/36

(52) U.S. Cl. CPC B23K 31/006; B23K 26/03; B23K 2101/36

(57) ABSTRACT

The disclosed subject matter may utilize multiple sensors to monitor the upstream, welding, or downstream characteristics, employ a machine learning algorithm to analyze the data, establish statistical process control, and develop an automated self-adaptive welding process improvement.

### CROSS REFERENCE TO RELATED APPLICATION(S)

The present application claims the benefit of U.S. Provisional Application No. 63/560,599, entitled “SMART LASER WELDING”, filed Mar. 1, 2024, the entirety of which is incorporated herein for reference.

### INTRODUCTION

Batteries are often used as a source of power, including as a source of power for electric vehicles that include wheels that are driven by an electric motor that receives power from the battery.

Aspects of the subject technology can help to improve the efficiency, range, and/or proliferation of electric vehicles, which can help to mitigate climate change by reducing greenhouse gas emissions.

### SUMMARY

This disclosure is generally directed to an approach for automated laser welding. In an example, the disclosed subject matter may utilize multiple sensors to monitor the upstream, welding, or downstream characteristics, employ a machine learning (ML) algorithm to analyze the data, establish statistical process control, and develop an automated self-adaptive welding process improvement.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a perspective view of a battery module in accordance with one or more implementations.

FIG. 4 illustrates an exploded perspective view of the battery module of FIG. 3 in accordance with one or more implementations.

FIG. 5 illustrate an exemplary system associated with a smart welding process.

FIG. 6 illustrates an exemplary method for smart laser welding, as disclosed herein.

FIG. 7 depicts a side view of a system for welding battery cells together.

FIG. 8 illustrates an exemplary method for smart laser welding, as disclosed herein.

FIG. 9 illustrates a side view of a portion of the battery cell in accordance with one or more implementations.

FIG. 10 illustrates a top view of a battery cell having a gasket with an asymmetric portion at a location corresponding to a weld in accordance with one or more implementations.

FIG. 11 illustrates an exemplary method for smart laser welding, as disclosed herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Battery manufacturing may be a lengthy process and seemingly small errors that accumulate along one or more steps may cause an unacceptable defect at the end of the manufacturing line. In addition to basic geometry and placement, misalignment of joint, bus bar distortion caused by previous welds, and surface contamination or oxidation of battery cells, current collector assemblies (CCAs) and bus bars can result in weld failures. In a factory setting, noise, vibration, dust, low lighting condition, or other variables may increase process variance and reduce process stability. The disclosed subject matter may establish a data-driven process control powered by a machine learning (ML) algorithm benchmarked against data reduction, regression analysis, or statistical control techniques. The data inputs may extend to account for incoming material and feedback of welding quality in downstream stations. The conditions of the battery components, manufacturing devices, or environmental factors may be considered before, during, or after welding. The disclosed approach may allow for welding conditions to be adjusted and controlled proactively through a ML decision making process by using upstream and downstream assembly data to tune significant variables that affect the weld quality.

Aspects of the subject technology described herein relate to a battery module. The battery module may include battery cells. The battery module may be implemented in a battery pack that includes multiple battery modules. The battery module may be implemented in an electric vehicle or other movable apparatus, and/or as a power source for a building or other stationary apparatus. Further details of various aspects of a battery module are described hereinafter.

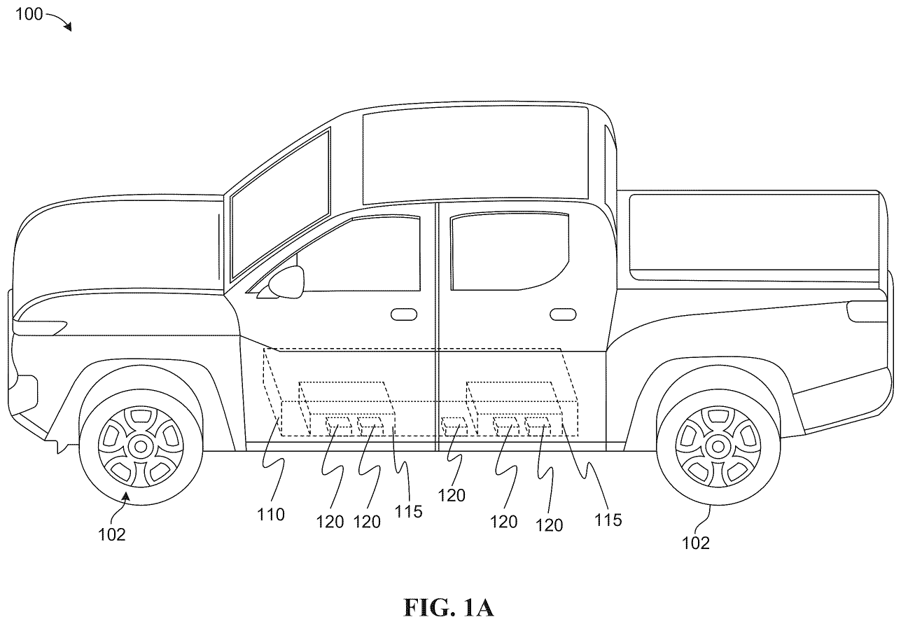

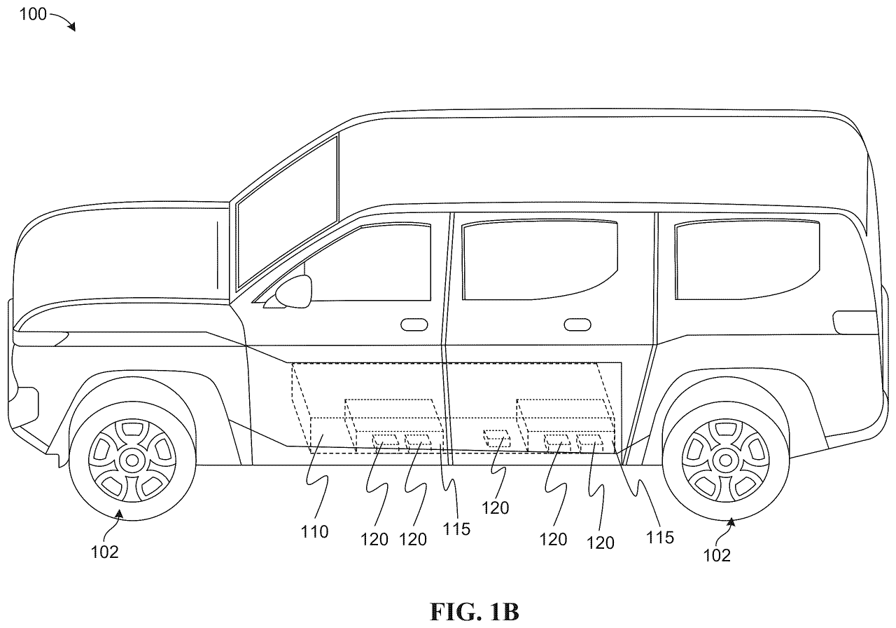

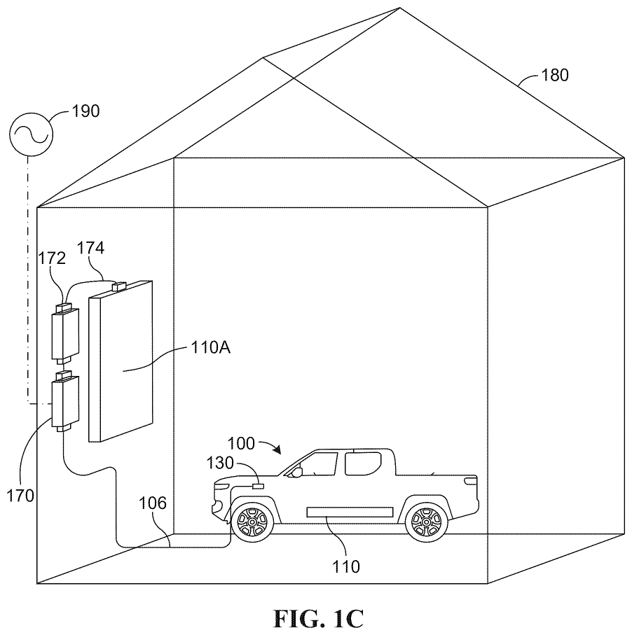

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery subassemblies, for example battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery subassembly, unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

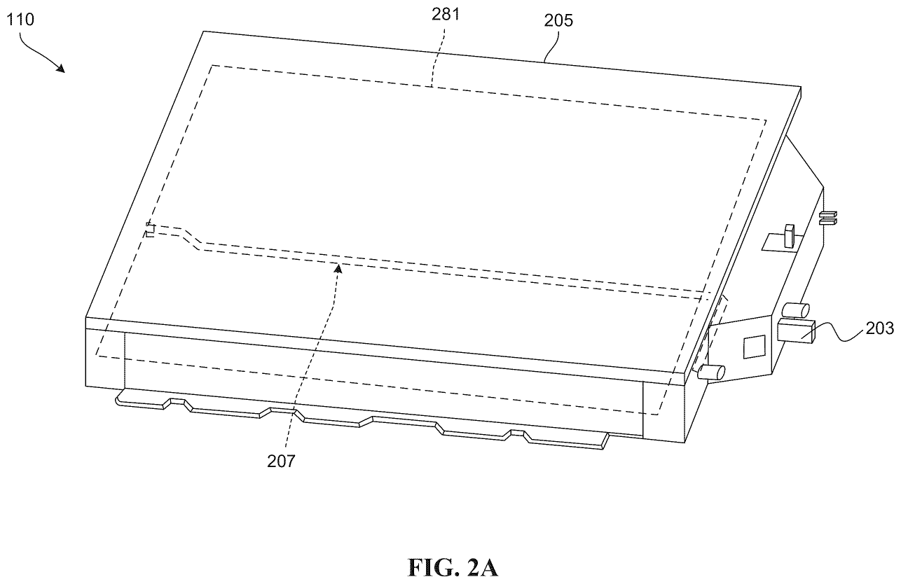

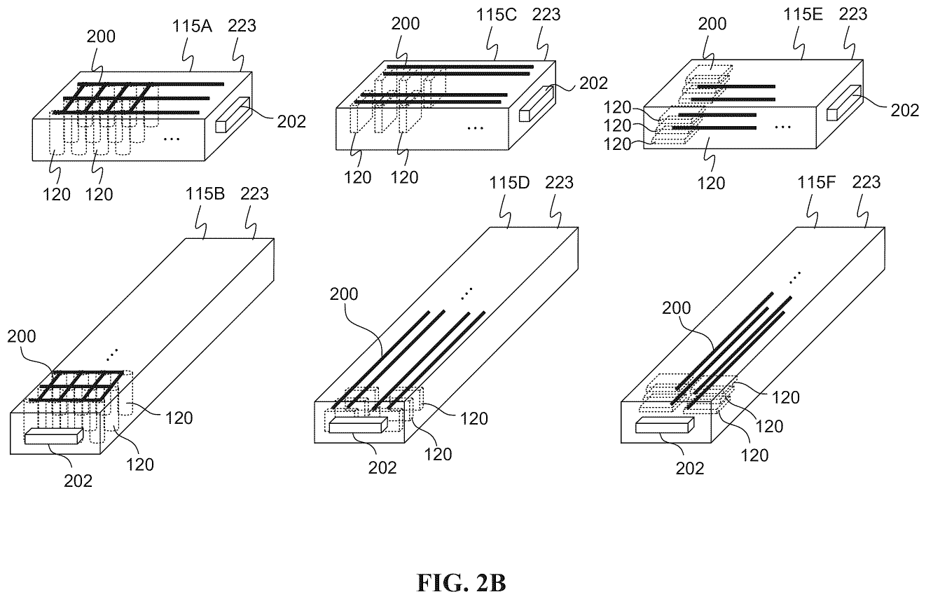

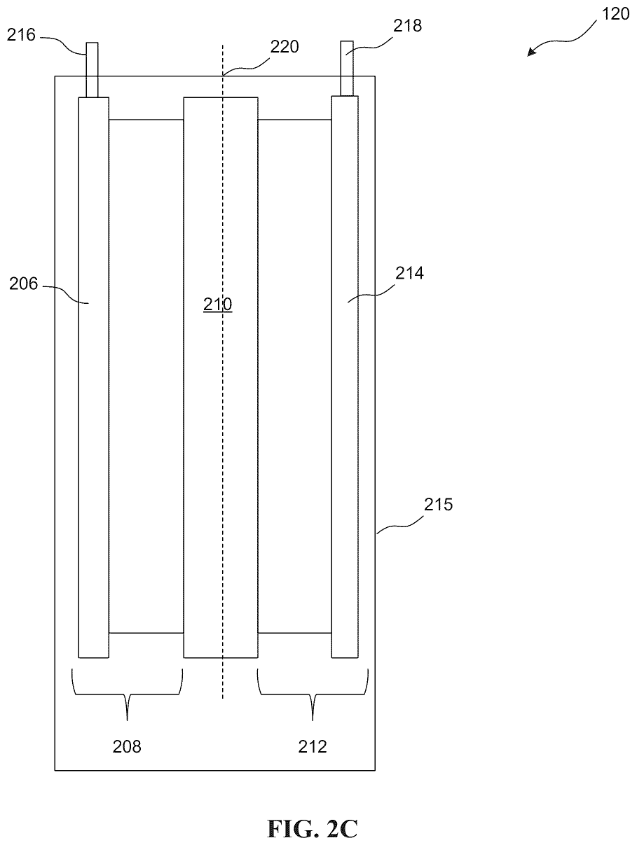

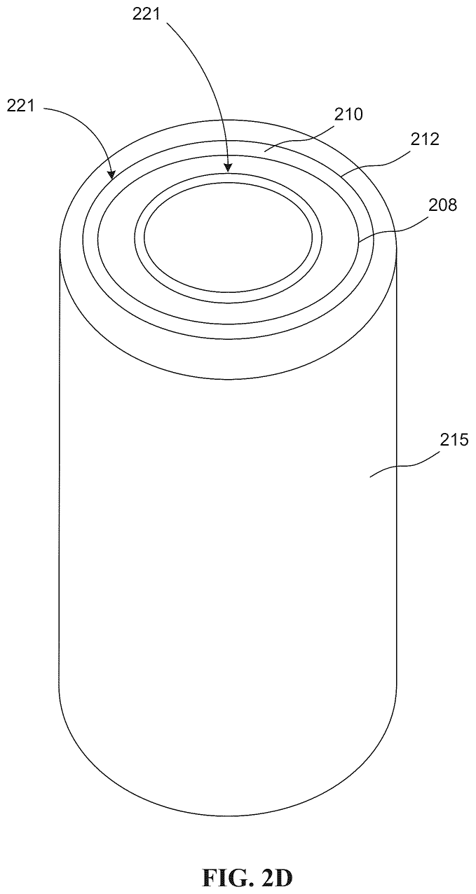

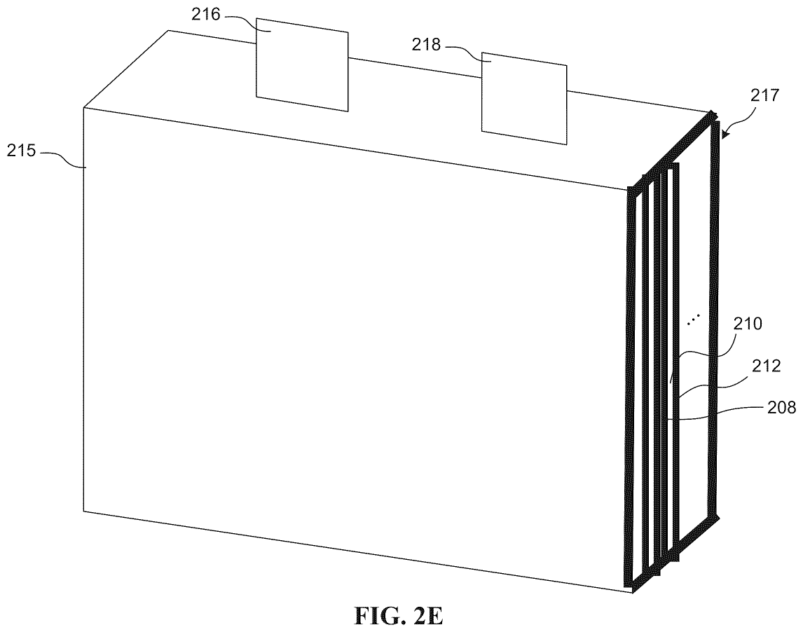

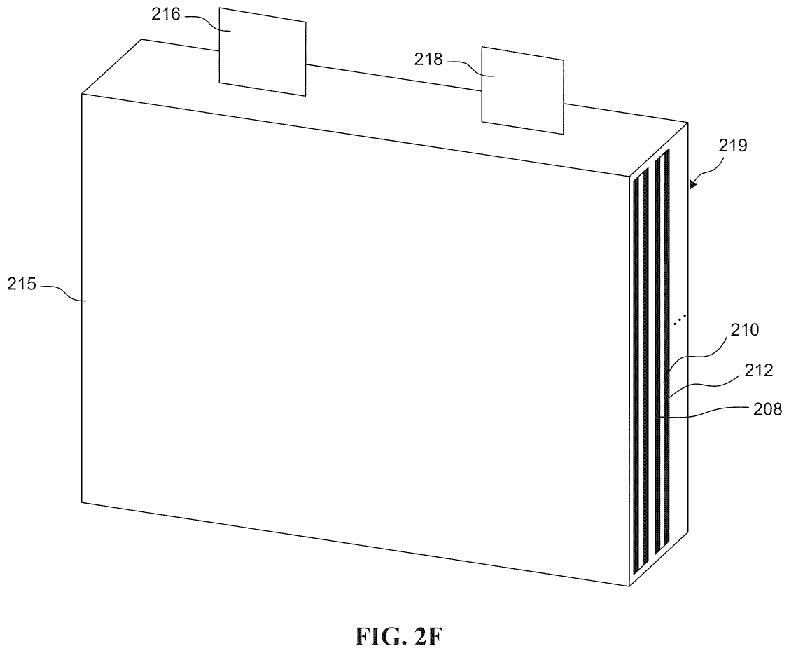

FIG. 2A depicts an example battery pack 110. Battery pack 110 may include multiple battery cells 120 (e.g., directly installed within the battery pack 110, or within batteries, battery units, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired output voltage for the battery pack 110. The battery pack 110 may also include one or more external connection ports, such as an electrical contact 203 (e.g., a high voltage terminal). For example, an electrical cable (e.g., cable/connector 106) may be connected between the electrical contact 203 and an electrical system of the vehicle 100 or the building 180, to provide electrical power to the vehicle 100 or the building 180.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules 115, battery units, batteries, and/or battery cells 120 within the battery pack frame 205, such as by distributing fluid through the battery pack 110.

For example, the thermal control structures 207 may form a part of a thermal/temperature control or heat exchange system that includes one or more thermal components 281 such as plates or bladders that are disposed in thermal contact with one or more battery modules 115 and/or battery cells 120 disposed within the battery pack frame 205. For example, a thermal component 281 may be positioned in contact with one or more battery modules 115, battery units, batteries, and/or battery cells 120 within the battery pack frame 205. In one or more implementations, the battery pack 110 may include one or multiple thermal control structures 207 and/or other thermal components for each of several top and bottom battery module pairs. As shown, the battery pack 110 may include an electrical contact 203 (e.g., a high voltage connector) by which an external load (e.g., the vehicle 100 or an electrical system of the building 180) may be electrically coupled to the battery modules and/or battery cells in the battery pack 110.

FIG. 2B depicts various examples of battery modules 115 that may be disposed in the battery pack 110 (e.g., within the battery pack frame 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the battery pack frame 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the battery pack frame 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the battery pack frame 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the battery pack frame 205) may include or define a plurality of structures for positioning of the battery cells 120 directly within the battery pack frame 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 215 having a right prismatic outer shape. As shown, one or more layers of the anode 208, the cathode 212, and the electrolyte 210 disposed therebetween may be disposed (e.g., with separator materials between the layers) within the cell housing 215 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 215 having the right prismatic shape. In the implementation of FIG. 2E, the cell housing 215 has a relatively thick cross-sectional width 217 and is formed from a rigid material. For example, the cell housing 215 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 215 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 215 (e.g., a glass to metal feedthrough) as the conductor passes through to cell housing 215 to expose the first terminal 216 and the second terminal 218 outside the cell housing 215 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 215 that forms a flexible or malleable pouch housing. In the implementation of FIG. 2F, the cell housing 215 has a relatively thin cross-sectional width 219. For example, the cell housing 215 in the implementation of FIG. 2F may be formed from a flexible or malleable material (e.g., a foil, such as a metal foil, or film, such as an aluminum-coated plastic film). For example, the cross-sectional width 219 of the cell housing 215 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 215 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

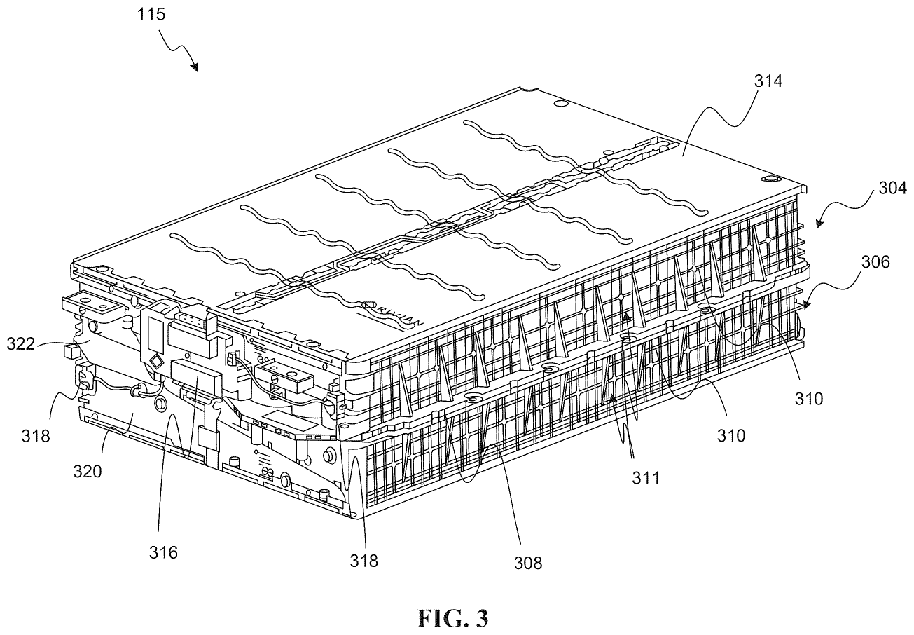

FIG. 3 illustrates a perspective view of a battery module in accordance with one or more implementations. In the example of FIG. 3, the battery module 115 includes a top submodule 304 and a bottom submodule 306. As shown, each of the top submodule 304 and the bottom submodule 306 may include a cell carrier 310. In one or more implementations, each cell carrier 310 may be a monolithic unitary body (e.g., a molded body formed from plastic and/or other materials), and may include structural features 311 along the sidewalls thereof. These structural features 311 may reinforce the strength of the sidewalls of the carrier, and thereby reduce or eliminate the need for additional structural reinforcing components for the battery module 115, such as shear walls attached to the cell carriers 310. Also visible in FIG. 3 is a cold plate 308 that is disposed between the top submodule 304 and the bottom submodule 306. The cold plate 308 may be in thermal contact with battery cells (not visible in FIG. 3) in the top submodule 304 and battery cells (not visible in FIG. 3) in the bottom submodule 306, to provide thermal control for both the top submodule 304 and the bottom submodule 306.

FIG. 3 also illustrates a cover 314 that may be disposed on a top and/or a bottom of the battery module 115. FIG. 3 also illustrates a balancing voltage and temperature (BVT) module 316 to which multiple thermistor assemblies 318 are communicatively coupled. The BVT can be a modular assembly of various electrical components to monitor or control components of the battery subassembly. For example, the BVT can include a circuit board that is attached to the housing of the BVT. The BVT can have various connectors to couple with, for example, a thermistor that can measure a temperature of the battery subassembly, battery module and/or a battery cell thereof, a voltage sensor or balancer that can sense or control voltage that flows through the battery subassembly, battery module and/or a battery cell thereof, or a communication device that can receive, transmit, or analyze data (also referred herein as information) associated with the battery subassembly, battery module and/or a battery cell thereof. Also shown in FIG. 3 are a busbar 320 (e.g., a positive busbar) that is electrically coupled to first terminals (e.g., the positive terminals) of the battery cells of the top submodule 304 and the bottom submodule 306, and a busbar 322 (e.g., a negative busbar) that is electrically coupled to second terminals (e.g., the negative terminals) of the battery cells of the top submodule 304 and the bottom submodule 306.

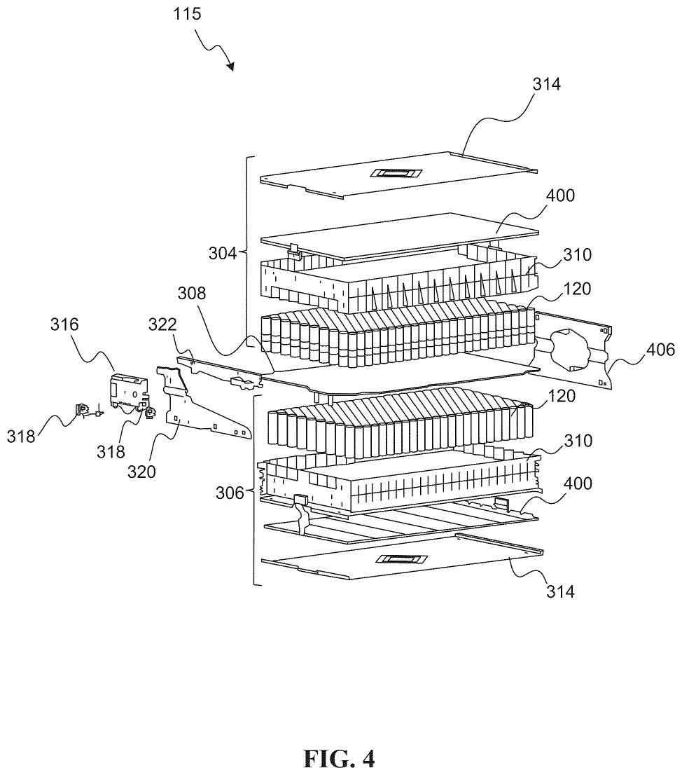

FIG. 4 illustrates an exploded perspective view of the battery module 115 of FIG. 3, in which the battery cells 120 of the top submodule 304 and the battery cells 120 of the bottom submodule 306 can be seen. In one or more examples described herein, the battery module 115, a subset of the components of the battery module 115 (e.g., the top submodule 304, the bottom submodule 306, and/or another subset of the components of the battery module) shown in FIG. 3 and/or FIG. 4, or any other grouping of battery cells (e.g., including a battery pack that includes multiple battery modules and/or other battery subassemblies) may be referred to as a battery subassembly.

In the example of FIG. 4, two current collector assemblies (CCAs) 400 are also visible which, when the battery module 115 is assembled, connect the terminals of the battery cells 120 of the top submodule 304 and the bottom submodule 306 to the busbar 320 and the busbar 322. As shown in FIG. 4, a series busbar 406 may also be provided (e.g., on an opposing end of the cell carriers 310 from the end of the cell carriers at which the busbar 320 and the busbar 322 are mounted). For example, the series busbar 406 may electrically couple the battery cells 120 of the top submodule 304 to the battery cells 120 of the bottom submodule 306. As shown, a cover 314 may be provided for the top submodule 304 and a cover 314 may be provided for the bottom submodule 306.

As discussed in further detail hereinafter, the battery cells 120 of the top submodule 304 may be inserted into a crate structure formed by the cell carrier 310 of the top submodule 304, and the battery cells 120 of the bottom submodule 306 may be inserted into a crate structure formed by the cell carrier 310 of the bottom submodule 306. As shown in FIGS. 3 and 4, the orientation of the cell carrier 310 and the battery cells 120 of the top submodule 304 may be substantially opposite (e.g., upside down with respect) to the orientation of the cell carrier 310 and the battery cells 120 of the bottom submodule 306. In this way, the single cold plate 308 can be in thermal contact with the same ends (e.g., bottom ends) of the battery cells 120 of both the top and bottom submodules, and provide substantially symmetric thermal contact with the top and bottom submodules.

In the fast-growing electric vehicle (EV) industry, battery manufacturing may be a significant stage of transport electrification. Battery packs, a significant component in electric vehicles, may face challenges due to complex design, lengthy manufacturing, or difficulty of achieving high yield in mass volume production. Welding may be used in connecting battery components. Laser welding, for example, may offer efficiency, productivity, or low electrical resistance, which may make it superior to some other methods. The high volume of welds in battery manufacturing may necessitate exceptional welding yield and process stability. Improving battery manufacturing yield may have a significant economic impact.

Some welding process monitoring systems may allow for process robustness or repeatability but may require sophisticated manual calibration or may not be able to accommodate large variations in a mass production environment. In addition, some welding process monitoring systems may work in an idealized setup, such as laboratory conditions, but not in real world environments, such as manufacturing environments. Limited data availability may hinder training of machine learning models (MLMs) for battery manufacturing, leading to issues in real-world applications.

The disclosed subject matter may allow for implementation of welding process monitoring and adjustments outside of a closed loop control and may more quickly prevent defects in multiple units when compared to conventional processes.

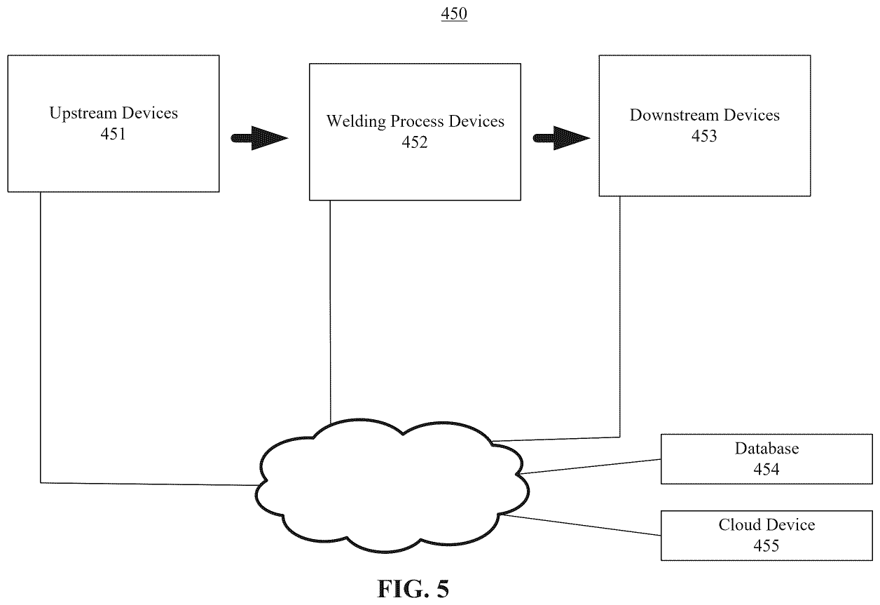

FIG. 5 illustrate an exemplary system 450 associated with a smart welding process. As shown, system 450 may include upstream devices 451, welding process devices 452, downstream devices 453, database 454, or cloud device 455 (e.g., server), which may be communicatively connected with each other.

Upstream devices 451 may include sensors that capture part fit-up, joint surface evaluation, welding features register, position of upstream battery components (e.g., as shown or described with regard to FIG. 1A-FIG. 4), upstream temperature, position of upstream robotic arms, or positioning of upstream conveyor belts, among other things. During the upstream process (e.g., before welding begins), machine vision may be used to map the position of battery cells in the carrier and identify misalignment on X-Y axes. Laser triangulation or 3D vision systems may detect the Z-height of the CCA and cells and detect air gaps. Fixtures may be adjusted automatically to correct local misalignment and reduce gaps that result in failed welds. In an example, the laser beam path may be adjusted to compensate for misalignment in X-Y directions. Surface profilometry can flag abnormal features on the surface, e.g., residual adhesives/contaminants, so measures may be taken to restore a clean surface for welding.

Welding process devices 452 may include sensors that capture laser welding power, laser welding speed, laser specular reflection laser emissivity, laser interferometry, welding process temperature, plasma emission, plume spectroscopy, or plume morphology. During the welding process, there may be optical coherence tomography (OCT) and inline coherent imaging (ICI) that may monitor stability of the laser welding process. In an example, a probe beam at a specific wavelength may detect the depth of the keyhole and calculate the penetration depth. Photodiodes may detect laser induced plasma and plume, which emit ultraviolet light. The temperature of the melt pool may be detected by an infrared (IR) sensor. Reflected beam intensity may correlate to heat input during the welding process. Multispectral optical data may be complemented by acoustic sensors as weld mode changes result in sound emissions. In some instances, in which there is short welding cycle time, single cycle close loop feedback control may not be achieved, but data from the current cycle may inform control of welding process for the next battery module via a ML algorithm.

Downstream devices 453 may include sensors that capture welding quality, temperature, position of downstream components (e.g., as shown or described with regard to FIG. 1A-FIG. 4), defect classification, weld sorting, electrical properties (including impedance, as well as frequency and time domain signal propagation characteristics), or weld marking, among other things. Downstream devices 453 may include components or apparatuses as shown or described with regard to FIG. 1A-FIG. 4. During the downstream process (e.g., after welding occurs), sensors may evaluate the 3D profile and probes may measure electrical resistance of the joints across the battery module. In an example, weld quality may be classified by combining the optical profilometry data and electrical resistance measurements. Unacceptable welds may be marked for rework, or the battery module may be rejected for manual examination before it moves to the next assembly steps.

It is contemplated that the sensors associated with upstream devices 451, welding process devices 452, downstream devices 453 may be used interchangeably at upstream stations, downstream stations, or welding process stations, unless otherwise advised. Note that additional sensors may include sensors that show the depth, width, or height of an area. Table 1 illustrates example process monitoring objectives and core technologies.

TABLE 1

| | | In-Welding- | |
|---|---|---|---|
| | Upstream | Process | Downstream |
| Monitoring | Battery cell height | Plasma & plume | Weld Integrity |
| Objectives | Battery cell in- | Keyhole | Electric |
| | position | stability | resistance |
| | Air gaps | Temperature | |
| | Surface contamination | Laser reflection | |
| Monitoring | Machine vision, | Optical coherence | 3D surface |
| Technologies | Laser triangulation, | tomography | profilometry |
| | Surface profilometry | Inline coherent | Electric |
| | | imaging | probing |
| | | Infrared | |
| | | thermography | |
| | | Acoustic | |
| | | emission | |

With continued reference to FIG. 5, database 454 may store data associated with the upstream process, welding process, or downstream process. As disclosed herein, the data may include other data such as versions (e.g., v1, v2, etc.) of components, suppliers (e.g., first company, second company, etc.) of components, sourcing of components, batch characteristics of components (e.g., same version but created or received at different periods), period of operation of one or more apparatuses (extended use may cause misalignment or need for maintenance), or strength of a laser from an apparatus, among other things. The components or apparatuses disclosed may be part of the battery components or machinery used to help manufacture the battery components. The data may be associated with upstream stations (e.g., upstream devices 451), welding stations (e.g., welding process devices 452), or downstream stations (e.g., downstream devices 453).

Cloud device 455 may be a computing device that uses graphical processing units (GPUs), general purpose computing (GPC), auxiliary processing units (APU), and the data of database 454 to train an MLM. Cloud device 455 may be located on premise or off premise. There may be other devices that perform the same or similar functions as cloud device 455 that may be edge nodes in close proximity to the upstream, downstream, or welding processes. These other devices may be preprocessing edge nodes. Cloud device 455 may send instructions to upstream devices, welding process devices, or downstream devices to implement operations based on the learned data. Within ML, algorithms may be used to inform the behaviors of system 450. This may be done via training data as provided in database 454 and the recognition of patterns. There are many subsidiaries associated with ML, including but not limited to, supervised learning, unsupervised learning, semi-supervised learning, and reinforcement learning. Training data, which may be obtained from database 454, may be information that is gathered and given to the system to develop a repertoire of situational actions and responses. Training is typically done at large and includes multiple pieces of data being input into the system in order to examine patterns and develop predictions. MLMs reference the trained data when processing unseen data and make informed decisions surrounding classification and next steps to be taken. The data processing step may generally include computational methods which help the machine learning including digital signal processing, wavelet decomposition, and expertise informed deterministic decision tree pruning.

For additional perspective, in some scenarios, (e.g., such as if a regression classifier is used) an untrained machine learning model may be trained using supervised learning, wherein a training dataset includes an input paired with a desired output, or where the training dataset includes input having known output and outputs of neural networks are manually graded. In some examples, the untrained machine learning model may be trained in a supervised manner. The training framework may process inputs from the training dataset and compare resulting outputs against a set of expected or desired outputs. In some examples, errors may then be propagated back through the untrained machine learning model. The training framework may adjust weights that control the untrained machine learning model. The training framework may include tools to monitor the convergence of an untrained machine learning model toward a trained model capable of producing correct outputs, such as results based on known input data, including new data. In some examples, the training framework trains the untrained neural network repeatedly while adjusting weights to refine an output of the untrained neural network using a loss function and adjustment process, such as stochastic gradient descent. In some examples, the training framework trains the untrained machine learning model until untrained neural network achieves a desired accuracy. The trained machine learning model may then be deployed to implement any number of machine learning operations. In some examples, the machine learning model may be trained to classify pixels of inputted image data into drivable and non-drivable space, for applications such as autonomous navigation.

In some examples, the untrained machine learning model may be trained using unsupervised learning, wherein the untrained machine learning model may attempt to train itself using unlabeled data. In some examples, the unsupervised learning training dataset may include input data without any associated output data or “ground truth” data. The untrained machine learning model can learn groupings within training dataset and can determine how individual inputs are related to the untrained dataset. In some examples, unsupervised training can be used to generate a self-organizing map, which is a type of trained machine learning model capable of performing operations useful in reducing dimensionality of new data. Unsupervised training can also be used to perform anomaly detection, which allows identification of data points in a new dataset that deviate from normal or existing patterns of the new dataset. In some examples, semi-supervised learning may be used, which is a technique in which the training dataset includes a mix of labeled and unlabeled data. The training framework may thus be used to perform incremental learning, such as through transferred learning techniques. Such incremental learning may enable the trained machine learning model to adapt to new data without forgetting knowledge instilled within the network during initial training.

In some examples, the MLM may be configured to employ a softmax layer (e.g., to obtain a normalized probability distribution), such as among multiple probabilities output by the model in connection with one or more of a category or class of the object, whether an object is present, and a location of a bounding box. In some examples, the MLM may be configured to apply an argmax function to such probabilities (e.g., to set each probability to zero or one).

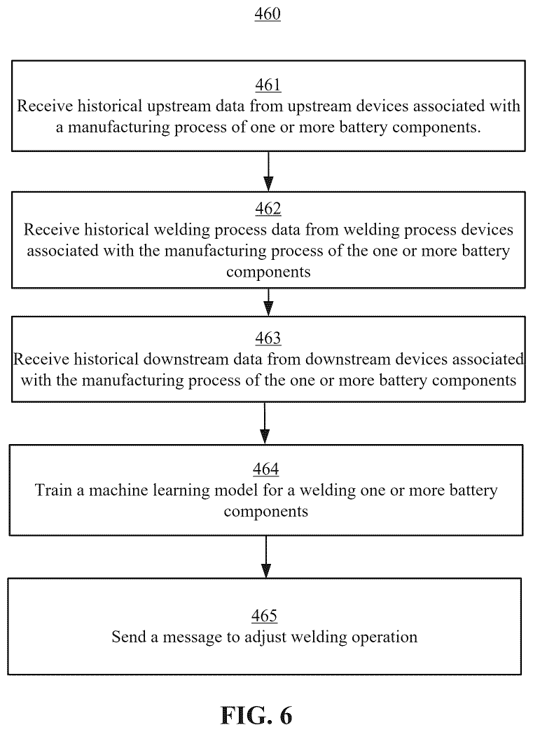

FIG. 6 illustrates an exemplary method 460 for smart laser welding, as disclosed herein. The disclosed steps may be performed on one or more devices of system 450, which may include cloud device 455. The disclosed steps herein may be performed in a different order than presented. At step 461, historical upstream data (also referred herein as information) may be received from upstream devices 451 associated with the manufacturing process of one or more battery components. Historical upstream data may include specs of battery components, such as geometric characteristics of the battery assembly coming from one or more upstream stations, specs of manufacturing equipment used in one or more upstream stations, or environmental conditions of one or more upstream stations, among other things. The upstream devices 451 may include the battery components or machinery used to help manufacture the battery components.

At step 462, historical manufacturing process data (also referred herein as historical welding process data) may be received from welding process devices 452 associated with the manufacturing process of one or more battery components. Historical welding process data may include specs of battery components, such as conductive characteristics or position of tabs of CCA 400, specs of manufacturing equipment used in one or more welding stations, or environmental conditions of one or more welding stations, among other things. The welding process devices 452 may include the battery components or machinery used to help manufacture the battery components. During laser welding, for example, parameters and process characteristics may be recorded by multiple optical, electrical, or thermal sensors. The different sensors may include microphones, vision sensors (e.g., charge-coupled devices (CCD)), complementary metal-oxide semiconductors (CMOS), or high-speed cameras (e.g., cameras with special filters applied to capture the images of the keyhole, molten pool, spatters and plasma). Spectrometers or photodiodes may be utilized to collect the optical signals (e.g., visible light, infrared light, or ultraviolet light). Thermal signals may be obtained by the use of infrared cameras, near-infrared cameras, or pyrometers.

At step 463, historical downstream data may be received from downstream devices 453 associated with the manufacturing process of one or more battery components. Historical downstream data may include specs of battery components, specs of manufacturing equipment used in one or more downstream stations, or environmental conditions of one or more downstream stations, among other things. The downstream devices 453 may include the battery components or machinery used to help manufacture the battery components. In an example, at a downstream station, the welded battery assembly may be scanned after the welding station to check the resultant welding quality which provides historical downstream data. In addition, the historical downstream data may be associated with throughput, cycle, time, capacity utilization, overall equipment effectiveness, dimensional accuracy, defect rate, or first pass yield, among other things, which may be obtained by various techniques.

At step 464, a welding process machine learning model (MLM) may be trained based on the historical upstream data, historical welding process data, or the historical downstream data. The data collected before, during or after, after the laser welding may be uploaded to database 454, in which cloud device 455 may execute advanced signal processing and sensor fusion techniques on the data which may assist with the training of the welding process MLM. In some examples, parameters and process characteristics recorded by multiple optical, electrical, or thermal sensors may be screened against a known benchmark to identify anomalies. The welding process MLM may be developed to analyze the data and provide feedback (e.g., alerts) or instructions to the devices of the manufacturing line (e.g., upstream devices 451, welding process devices 452) before the next battery assembly is welded.

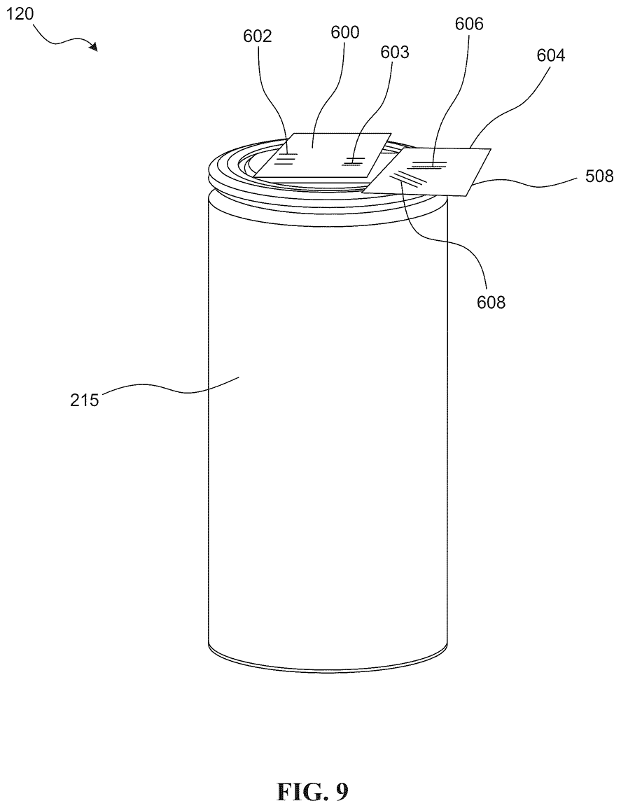

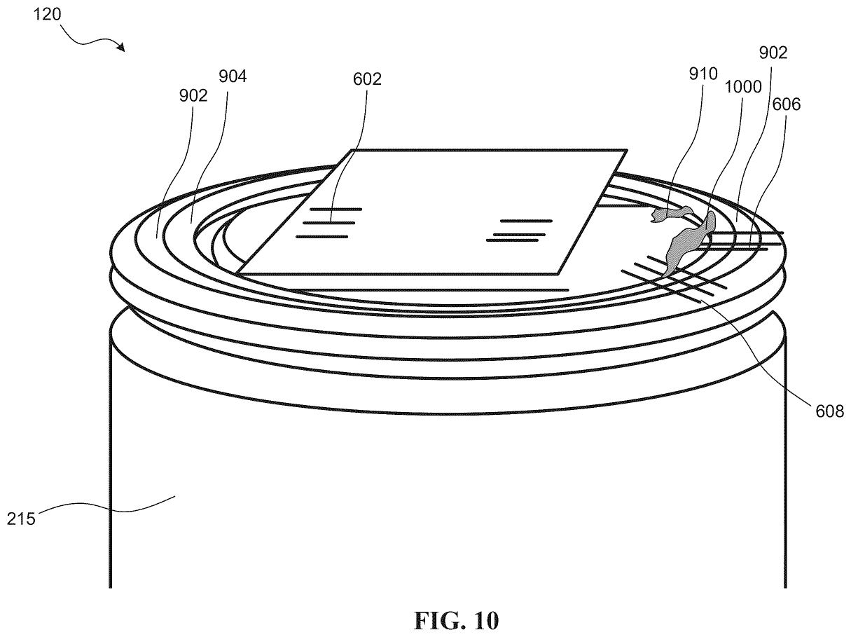

At step 465, send a message based on the MLM of step 464. The welding quality may be disturbed by various factors during welding process, such as the internal defects of materials and the complex manufacturing environment. Based on the MLM, an alert may be sent regarding such possible suboptimal component condition that is not within acceptable parameters or an indication to adjust welding to account for suboptimal component condition that is not conventionally within acceptable parameters but may be made acceptable by appropriately adjusting the welding technique (e.g., increasing the number of welds or the angle of the welds), see FIG. 9-FIG. 10. In an example, welding processing MLM may determine that the position of battery cell 120 within battery module 115 may call for a different type or position of a weld, which may allow for a better connection with CCA 400.

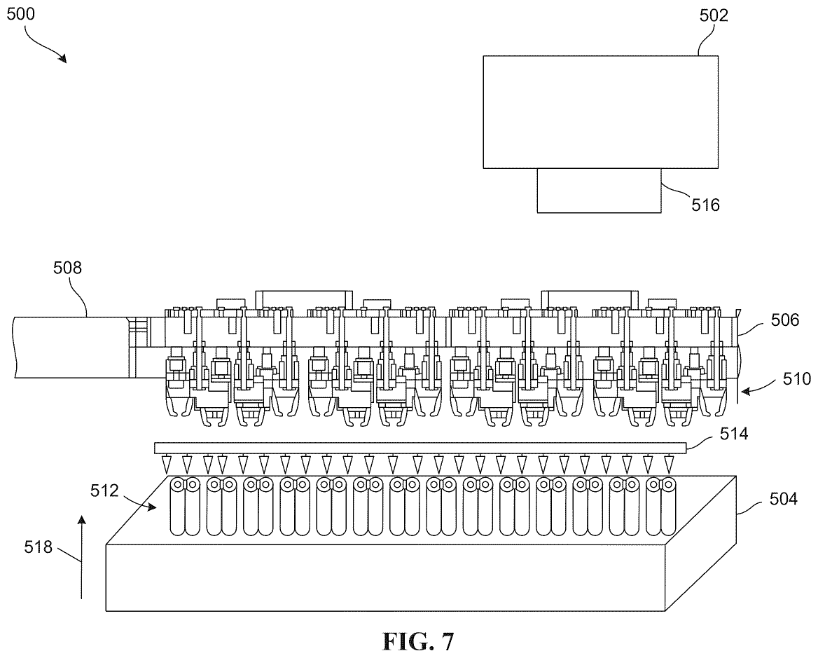

FIG. 7 illustrates an example scenario for smart laser welding as disclosed herein. The described clamp of FIG. 7 may be useful but may be prone to periodic misalignment based on factory conditions. One or more clamps may expand, crack, or be out of position. As the welds are mere millimeters, in a conventional setting, misalignment may cause several costly or time consuming issues before corrective action is taken. The disclosed subject matter may allow for diagnosis and responsive action based on received sensor data processed through the disclosed MLM.

FIG. 7 depicts a side view of a system 500 for welding battery cells together. As described herein, the system 500 can be an apparatus. The system 500 can include a welding device 502, a battery module 504, a plate 506, and a board 508. The plate 506 can be coupled with the board 508. Any number of the plates 506 can be coupled with the board 508. Clamps 550 can be coupled to or with the plate 506. The battery module 504 can include one or more battery cells 512. The battery module 504 and the one or more battery cells 512 can be the same as or similar to the battery module 115 and the battery cells 120, shown and described herein. Current collectors can overlay the battery cells 512. The clamps 510 can receive the battery cells 512 and current collectors and clamp the battery cells 512 to the current collectors. Clamping the battery cells 512 with the current collectors can align the current collectors with specific portions of the battery cells 512 (e.g., cause current collectors to overlay specific portions of the battery cells 512). While clamped, the welding device 502 can direct a laser 516 at the current collectors on the battery cells 512. Thus, the plate 506, the board 508, and the clamps 510 can operate as a welding mask to facilitate welding of battery cells.

The battery module 504 can include one or more rows of battery cells 512. The rows of battery cells can be separated by barrier sheets. The barrier sheet can electrically isolate the battery cells from each other. The edges of the battery module 504 can include walls that electrically isolate the battery cells 512 positioned with the battery module 504 from objects that contact the outside of the battery module 504. The battery cells 512 can be held in place by a cell carrier that fits around the individual battery cells. In some cases, the battery cells 512 can be grouped together outside of a barrier module (e.g., outside of a container with barriers between the battery cells 512). Welding battery cells 512 outside of a battery module can be useful for welding battery cells in a cell-to-pack configuration in which battery modules are not used.

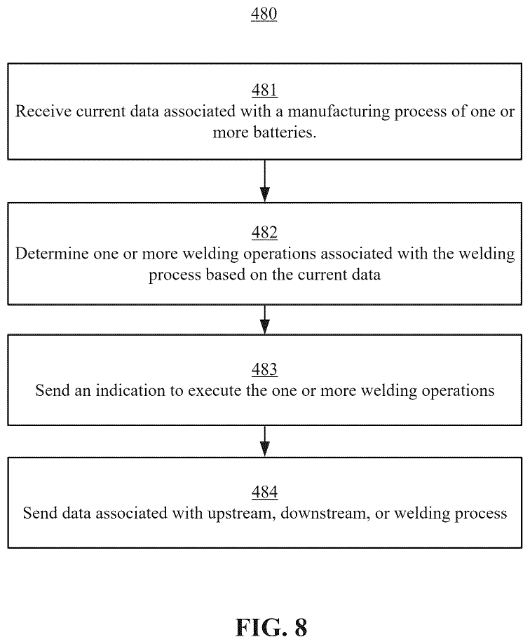

FIG. 8 illustrates an exemplary method 480 for smart laser welding, as disclosed herein. The disclosed steps may be performed on one or more devices of system 450, which may include cloud device 455. The disclosed steps herein may be performed in a different order than presented. At step 481, current upstream data may be received from upstream devices associated with a manufacturing process of one or more batteries. At step 482, \ the welding process MLM based on the current upstream data may be determined one or more operations of a welding apparatus. As disclosed herein, the operations may vary and may include adjusting position of welds, increasing power of the laser, decreasing power of the laser, or the like. At step 483, an indication to execute the one or more operations of the welding process apparatus (e.g., a signal to a robotic arm, laser welder, clamp, or another device) may be sent. At step 484, upstream data, welding process data, or downstream data may be sent from one or more devices to database 454. This will cause for the continued update and training of the MLM.

FIG. 9 and FIG. 10 illustrate example scenarios for smart laser welding as disclosed herein. The described weld may not occur cleanly based on a misalignment. As the welds are mere millimeters, in a conventional setting, misalignment may cause several costly or time consuming issues before corrective action is taken. The disclosed subject matter may allow for diagnosis and responsive action based on received sensor data processed through the disclosed MLM. Therefore, the scenario associated with FIG. 9 and FIG. 10 may be addressed using the disclosed methods, such as described regarding FIG. 6 and FIG. 8. In an example, based on machine learning (e.g., learning of computer vision indicating inappropriate welds), one or more of the components associated with the welds (e.g., laser weld components, battery components, or conveyor components, etc.) may be adjusted to correct and minimize the inappropriate welds.

FIG. 9 illustrates the example battery cell after having been connected to one or more connectors, in accordance with one or more implementations. In the example of FIG. 9, a connector 600 is connected to the central portion of the cap of the battery cell using a weld 602 and a weld 603. In this example, each of the weld 602 and the weld 603 is formed from a set of multiple (e.g., two, three, four, five, or more than five) welds, such as approximately parallel welds. In the example of FIG. 9, a connector 604 is connected to the peripheral rim 902 as shown in FIG. 10 of the cap of the battery cell using a weld 606 and a weld 608. In this example, each of the weld 606 and the weld 608 is formed from a set of multiple (e.g., two, three, four, five, or more than five) welds, such as approximately parallel welds. In one or more implementations, the connector 600 or the connector 604 may be tabs of the current collector assembly (CCA) 400 described herein in connection with FIG. 4.

FIG. 10 illustrates an example in which a portion 1000 of the portion 910 of the gasket 904 is asymmetric (e.g., deformed, or previously melted) at the location of a weld 606 on the peripheral rim 902. As shown in FIG. 10, a portion 910 of the gasket 904 may extend beyond an inner radial edge of the peripheral rim 902 (e.g., and may be exposed to the external environment of the battery cell or to welding activity that occurs externally to the battery cell). Because the width of the weld 606, the weld 608 may be greater than the width, of the peripheral rim 902, the process of welding the connector 604 to the peripheral rim 902 may cause the portion 910 of the gasket 904 to be directly targeted by a welding component (e.g., a laser performing the welding process), particularly, for example, in a use case in which the weld(s) are misaligned (e.g., due to alignment offsets introduced by prior manufacturing processes for battery cell or battery subassembly). This can cause some part(s) of the portion 910 of the gasket 904 to melt during the welding process and then re-solidify after welding (e.g., in a deformed, or previously melted, configuration). For example, the melting and re-solidifying of a portion of the gasket 904 at the location of the weld 606 or the weld 608, or the like weld can cause the gasket to include an asymmetric portion at or near the location of one or more welds. For example, the gasket 904 may be a substantially circumferentially (azimuthally) or radially symmetric gasket prior to the welding process and, may include, following the welding, a circumferentially (azimuthally) or radially asymmetric portion (e.g., a deformed portion) at or near the location of a weld on the peripheral rim 902, due to a previous melting of that portion.

The disclosed smart laser welding process may offer high yield, adaptability, reliability, or efficiency for joining battery components. The disclosed subject matter may allow it to self-evolve for different product designs or manufacturing environments.

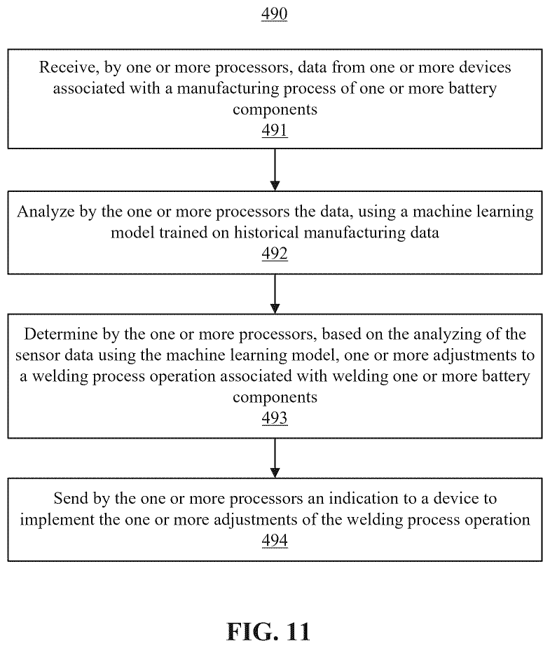

FIG. 11 illustrates an example method 490 for adaptive laser welding control in manufacturing as disclosed herein. At step 491, data may be received by one or more processors from one or more devices associated with a manufacturing process of one or more battery components. The data collection may be comprehensive, incorporating inputs from multiple sensor types strategically positioned throughout the manufacturing line. These sensors may include thermal sensors for monitoring temperature variations and heat distribution during the welding process, image sensors for visual inspection and real-time monitoring of weld formation, or position sensors for precise tracking of component alignment and welding head placement. This multi-modal sensing approach may help ensure a more complete understanding of the manufacturing environment and process conditions.

At step 492, the processors may analyze the collected data using a machine learning model that has been trained on extensive historical manufacturing data. This historical training data may encompass various aspects of the manufacturing process, such as environmental conditions across different stations (such as humidity, temperature, lighting, or air quality), detailed specifications of the manufacturing equipment (such as maintenance records, calibration data, or operational parameters), or comprehensive specifications of the battery components being processed (such as material properties, dimensional tolerances, or surface characteristics). The machine learning model may employ various algorithms, including but not limited to deep learning networks, random forests, or ensemble methods, to identify patterns or correlations within the data that might not be apparent through traditional analysis methods.

At step 493, based on the analysis of the sensor data using the machine learning model, the processors may determine one or more adjustments to the welding process operation associated with welding the battery components, for example with reference to FIG. 9 and FIG. 10 These adjustments may be highly precise and tailored to the specific conditions detected by the sensors. Example aspects of weld optimization that may be adjusted are the angle of the welds, the focal position of the laser beam or the number of welds applied to the battery components. The angle adjustment capability may allow for optimal energy transfer or joint formation, which may be significant when dealing with different material thicknesses or complex geometries. The shift of laser focal position may compensate for the Z height variation of the cell so that the laser-materials interaction will always be in the optimal condition. The ability to dynamically adjust the number of welds may enable the system to ensure structural integrity while maintaining production efficiency, adapting to varying component qualities or environmental conditions that might affect weld strength.

At step 494, the processors may send an indication to a device to implement the determined adjustments of the welding process operation. This implementation may occur in real-time, allowing for immediate correction of any detected issues or optimization opportunities. The system may also include feedback mechanisms to verify that the implemented adjustments achieve the desired outcomes, which may create a looped control system that may continuously refine or improve the welding process. In welding related examples, this adaptive approach may help maintain consistent weld quality while maximizing production efficiency or minimizing material waste.

The disclosed intelligent welding control system (e.g., system 450) may help advance manufacturing, such as battery manufacturing automation, by combining technologies (e.g., sensor technology, machine learning capabilities, and process control) to achieve optimal welding outcomes. The ability of the system to adapt to changing conditions and learn from historical data may make it valuable in high-volume manufacturing, such as battery production environments.

The data analysis from the machine learning model may identify when welding conditions are unsuitable for achieving acceptable quality standards, prompting the system to flag specific battery components for further evaluation or alternative processing routes, thereby preventing potential defects and material waste. In an example, the data analysis results may indicate that laser welding should not be attempted and one or more battery components may be redirected for additional consideration. The disclosed subject matter may leverage historical welding data, a comprehensive analysis of upstream part geometry, fit-up, in-welding processes, or downstream quality checks to enable the manufacturing line to adjust welding parameters and adapt to variations in the next battery assembly. The welding process MLM may be able to predict (e.g., using a welding quality classifier) and schedule maintenance needs prior to a predicted catastrophic failure. Such maintenance predictions may minimize downtime or lower equipment upkeep costs. With each additional battery assembly processed in the line, more data may be collected to train the ML algorithm, and the welding line may become “smarter,” resulting in detection and prevention of defects necessary to increase first pass yield.

Methods, systems, and apparatuses, among other things, as described herein may provide for designated low-speed area automated mode. For example, a system may include a one or more sensors and a cloud device or edge node communicatively connected with the one or more sensors. The methods, systems, or apparatuses may provide for operations that comprise receive upstream data from upstream devices associated with a manufacturing process of one or more battery components or manufacturing components; determine, based on the upstream data, a welding process operation for the one or more battery components; and send an indication to a welding device to implement the welding process operation. All combinations in this paragraph (including the removal or addition of steps or components) are contemplated in a manner that is consistent with the other portions of the detailed description.

The methods, systems, or apparatuses may provide for operations that comprise receive historical upstream data from upstream devices associated with a manufacturing process of one or more battery components; receive historical welding process data from welding process devices associated with the manufacturing process of the one or more battery components; receive historical downstream data from downstream devices associated with the manufacturing process of the one or more battery components; training a welding process machine learning model (WP MLM) based on a combination of the historical upstream data, historical welding process data, or the historical downstream data; receive current upstream data from upstream devices associated with a manufacturing process of a subsequent one or more batteries; determining, by the WP MLM based on the current upstream data, one or more operations of a welding apparatus; and sending an indication to execute the one or more operations of the welding apparatus. All combinations in this paragraph or previous paragraphs (including the removal or addition of steps or components) are contemplated in a manner that is consistent with the other portions of the detailed description.

Note the methods or systems disclosed herein may be performed by computing equipment. The computing equipment may include mobile devices (e.g., tablet computers), servers, or any other device that can execute computing functions. Although not required, the methods and systems disclosed herein may be described in the general context of computer-executable instructions, such as program modules, being executed by a computer (e.g., with processor or memory), such as a server or mobile computing device. Generally, program modules include routines, programs, objects, components, data structures and the like that perform particular tasks or implement particular data types. In a distributed computing environment, program modules may be located in both local and remote memory storage devices. All combinations in this paragraph and the previous paragraphs (including the removal or addition of steps or components) are contemplated in a manner that is consistent with the other portions of the detailed description.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, or systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method comprising:
receive, by one or more processors, data from one or more devices associated with a manufacturing process of one or more battery components;
analyzing the data by the one or more processors, using a machine learning model trained on historical manufacturing data;
determining by the one or more processors, based on the analyzing of the data from the one or more devices using the machine learning model, one or more adjustments to a welding process operation associated with welding one or more battery components; and
sending by the one or more processors an indication to a device to implement the one or more adjustments of the welding process operation.

2. The method of claim 1, wherein the data is associated with one or more thermal sensors.

3. The method of claim 1, wherein the data is associated with one or more image sensors.

4. The method of claim 1, wherein the data is associated with one or more position sensors.

5. The method of claim 1, wherein the historical manufacturing data comprises one or more parameters associated with one or more environmental conditions of one or more stations.

6. The method of claim 1, wherein the historical manufacturing data comprises one or more parameters associated with specifications of manufacturing equipment used in one or more stations.

7. The method of claim 1, wherein the historical manufacturing data comprises one or more parameters associated with specifications of one or more battery components.

8. The method of claim 1, wherein the one or more operations comprise adjusting an angle of one or more welds on the one or more battery components.

9. The method of claim 1, wherein the one or more operations comprise adjusting an amount of welds on the one or more battery components.

10. A system comprising:
one or more devices associated with manufacturing of one or more battery components;
one or more processors; and
memory storing instructions that, when executed by the one or more processors, cause the processor to:
receive data from one or more devices associated with a manufacturing process of the one or more battery components;
analyze the data, using a machine learning model trained on historical manufacturing data;
determine, based on the analyzing of the data from the one or more devices using the machine learning model, one or more adjustments to a welding process operation associated with welding one or more battery components; and
send an indication to the one or more devices to implement the one or more adjustments of the welding process operation.

11. The system of claim 10, wherein the data is associated with one or more thermal sensors.

12. The system of claim 10, wherein the data is associated with one or more image sensors.

13. The system of claim 10, wherein the data is associated with one or more position sensors.

14. The system of claim 10, wherein the historical manufacturing data comprises one or more parameters associated with one or more environmental conditions of one or more stations.

15. The system of claim 10, wherein the historical manufacturing data comprises one or more parameters associated with specifications of manufacturing equipment used in one or more stations.

16. The system of claim 10, wherein the historical manufacturing data comprises one or more parameters associated with specifications of one or more battery components.

17. The system of claim 10, wherein the one or more operations comprise adjusting an angle of one or more welds on the one or more battery components.

18. The system of claim 10, wherein the one or more operations comprise adjusting an amount of welds on the one or more battery components.

19. An apparatus comprising:
one or more processors; and
memory storing instructions that, when executed by the one or more processors, cause the processor to:
receive data from one or more devices associated with a manufacturing process of one or more battery components;
analyze the data, using a machine learning model trained on historical manufacturing data;
determine, based on the analyzing of the data from the one or more devices using the machine learning model, one or more adjustments to a welding process operation associated with welding one or more battery components; and
send an indication to one or more devices to implement the one or more adjustments of the welding process operation.

20. The apparatus of claim 19, wherein the data is upstream sensor data that component fit-up data, joint surface evaluation data, or welding features register data.
